(19) United States
(12) Patent Application Publication
(10) Pub. No.: US 2008/0048931 A1
(43) Pub. Date: Feb. 28, 2008

(54) Helmet System for Information or Weapon Systems

(75) Inventor: Tsafrir Ben-Ari, Shimshit (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: RAFAEL - ARMAMENT DEVELOPMENT AUTHORITY LTD., HAIFA (IL)

(21) Appl. No.: 10/596,006

(22) PCT Filed: Nov. 18, 2004
(86) PCT No.: PCT/IL2004/001067

§ 371 Date: Apr. 19, 2007

(30) Foreign Application Priority Data
Nov. 26, 2003 (IL) 159061

(51) Int. Cl. G09G 5/00

(52) U.S. Cl. 345/8

(57) ABSTRACT

A helmet position measuring system for use in a predefined environment. The system includes a helmet-mounted illumination system for directing electromagnetic radiation of one or more wavelength from the helmet in one or more range of angles, a set of three or more passive reflectors deployed at fixed positions in the predefined environment to reflect electromagnetic radiation from the illumination system, a helmet-mounted imaging system sensitive to the one or more wavelength for deriving images of part of the predefined environment including electromagnetic radiation reflected from the reflectors, and a processing system associated with the imaging system for processing the images to identify regions of the images corresponding to the reflectors and hence to determine information relating to a position of the helmet within the predefined environment.

### FIELD AND BACKGROUND OF INVENTION

The present invention relates to helmets for use in automated systems and, in particular, it concerns a helmet system for use with weapon or information systems which requires minimal integration with other systems. Various aspects of the invention relate to a helmet position tracking system and an eye-motion tracing system, and the associated methods of operation.

It has become increasingly common for automated systems, particularly in the field of aeronautics, to employ systems integrated with a helmet worn by a pilot as an inter part of an automated system. For example, in helmet sights, a helmet position sensing system follows the angular position of the helmet and directs a weapon system to align with a fixed sight mounted on the helmet. In more sophisticated systems, a helmet mounted display (HMD) provides numerous additional features, including providing visible indicators aligned with objects viewed by the pilot.

In all such systems, the position (angular position and/or linear displacement) of the helmet relative to the platform on which it is used must be measured to a high degree of accuracy. On fixed terrestrial platforms, helmet position monitoring may be performed using relatively simple and low-cost inertial sensors, alone or in combination with other sensors. For moving platforms, however, helmet-mounted inertial sensors are not sufficient due to the non-inertial (i.e., subject to acceleration) nature of the platform itself. Thus, pilot helmet position systems for use in aircraft generally employ either a magnetic or an optical position measurement system.

Magnetic helmet position sensing systems are widely used, but suffer from a number of disadvantages. Most notably, the use of magnetic helmet position sensing systems has a highly labor intensive set-up procedure, requiring time-consuming mapping of the magnetic fields of the entire cockpit environment, and requiring re-mapping whenever a change is made to the cockpit arrangement.

Optical helmet position sensing systems, on the other hand, suffer from their own disadvantages. Optical systems typically employ a cockpit-mounted imaging sensor to identify optical markers such as active LED's or reflective patches located on the helmet. If the helmet can turn tough a wide range of angles, the optical markers may not always be within the field of view (“FOV”) of the imaging sensor. Where reliable continuous helmet tracing over a wide range of angles is required, multiple image sensors viewing from different angles may be needed.

U.S. Pat. No. 6,377,401 to Bartlett describes a hybrid system in which a helmet-mounted camera obtain images of active markers located in the cockpit as a self-check or correction for measurements by a magnetic sensor system.

All of the aforementioned types of helmet position sensors require a significant degree of integration into the aircraft systems. Specifically, components of the magnetic and/or optical system must typically be installed in various locations within the cockpit. Furthermore, the systems typically red transfer of data via the aircraft electronics systems, or alternatively, via dedicated installed wiring. In either case, the process of integration requires re-evaluation and testing for the safety, operational and reliability standards required by the relevant aviation authorities, a process which is typically very costly and may take months or years. These testing and certification procedures themselves act as a major deterrent to adoption of many new systems which, in themselves, would otherwise be highly advantageous.

A co-assigned, co-pending U.S. Patent Application, published as Publication No. 20020039073 discloses a helmet-based cuing system which employs eye-tracking to provide a wide range of advanced features without requiring a helmet mounted display. This document is hereby incorporated by reference as if fully set out herein.

Although offering many advantages, the aforementioned patent application describes a system based upon otherwise conventional helmet position sensing systems and eye-gaze direction sensing systems. As a result, the implementation of each subsystem inherently requires some significant degree of integration into the cockpit environment.

Turning now to eye-tracking systems, it is known to use images of the eye together with image processing to derive the gaze direction of the eye. Commercial eye-tracking systems are available from ASL Applied Science Laboratories (Bedford, Mass., USA) and from SR Research Ltd. (Mississauga, Ontario, Canada). These systems typically operate using IR wavelength illumination and imaging of the eye in order to avoid the visual disturbance which would be caused by illumination with visible light.

Existing eye-tracking systems generally operate in one or other of two modes. In a first mode, the system identifies the position of the pupil and of a direct corneal reflection or “glint” of the reflected illumination source. The gaze direction is then derived from the vector difference between the pupil centroid and the glint. This mode can provide good results which are relatively insensitive to vibration or misalignment of the apparatus. However, the pupil-plus-glint mode is only operative over a relatively small range of angles where the direct corneal reflection is visible to the imaging sensor. For applications where this small range of angles is insufficient, a different mode relying upon pupil position only is used. The pupil-only mode is highly sensitive to misalignment of the apparatus and other mechanical distances. As a result, no currently available system is capable of tracking eye-movements over a wide range of angles while also compensating for errors due to shifting of aliment and other mechanical disturbances.

There is therefore a need for a helmet system and corresponding methods for use in automated systems which would provide an accurate indication of helmet position and/or eye-gaze direction of a user on a stationary or moving platform while minimizing the required degree of integration into existing systems of the platform. It would also be highly advantageous to provide an eye-tracking system and corresponding method which would track eye movements over a wide range of angles while providing automatic correction for variations in system alignment.

### SUMMARY OF THE INVENTION

The present invention provides a helmet position measuring system and a helmet mounted eye-gaze direction sensing system together with associated methods.

According to the teachings of the present invention there is provided, a helmet position measuring system for use in a predefined environment, the system comprising: (a) a helmet-mounted illumination system for directing electromagnetic radiation of at least one wavelength from the helmet in at least one range of angles; (b) a set of at least three passive reflectors deployed at fixed positions in the predefined environment so as to reflect electromagnetic radiation from the illumination system; (c) a helmet-mounted imaging system sensitive to at least the at least one wavelength for deriving images of part of the predefined environment including electromagnetic radiation reflected from the reflectors; and (d) a processing system associated with the imaging system for processing the images to identify regions of the images corresponding to the reflectors and hence to determine information relating to a position of the helmet within the predefined environment.

According to a further feature of the present invention, the illumination system includes at least one infrared LED.

According to a further feature of the present invention, the imaging system is at least partially selective to electromagnetic radiation of at least one wavelength.

According to a further feature of the present invention, the illumination system directs the electromagnetic radiation substantially continuously within a horizontal angular range of at least 60°.

According to a further feature of the present invention, the illumination system directs the electromagnetic radiation substantially continuously within a vertical angular range of at least 40°.

According to a further feature of the present invention, at least part of the processing system is located in a housing external to, and electrically interconnected with, the helmet, the housing being configured for wearing on the body of a user.

According to a further feature of the present invention, there is also provided an inertial measurement system associated with the helmet and connected to the processing system for providing additional information relating to a position of the helmet.

According to a further feature of the present invention, the inertial measurement system includes three angular motion sensors deployed in fixed relation to the helmet so as to sense rotational motion about three orthogonal axes.

According to a further feature of the present invention, the helmet has a convexly curved external surface, and herein the three angular motion sensors are mounted in proximity to substantially mutually orthogonal regions of the curved external surface.

According to a further feature of the present invention, the helmet has a convexly curved external surface, the system further comprising a cover element attached to the helmet, the cover element having a concave surface facing the convexly curved external surface of the helmet, wherein the three angular motion sensors are mounted relative to the cover element at substantially mutually orthogonal regions of the concave surface.

According to a further feature of the present invention, the predefined environment is part of a moving platform the moving platform having at least one associated platform position measurement system, the helmet position measuring system further comprising a communications link associated with the processing system and with at least one element on the moving platform, the communication link transferring platform position information derived from the at least one platform position measurement system to the processing system, and wherein the processing system is configured to compute inertially-derived relative motion information relating to motion of the helmet within the predefined environment by comparing the information from the inertial measurement system with the platform position information.

According to a further feature of the present invention, the processing system is configured to employ an adaptive filter calculation to combine the inertially-derived relative motion information and the position information derived from the images to generate overall helmet position information.

According to a further feature of the present invention, the communications link is implemented as a wireless communications link.

According to a further feature of the present invention, the communications link is associated with at least one of the group: a processing unit within a missile; and a processing unit within a missile launcher.

According to a further feature of the present invention, there is also provided a helmet-mounted eye-tracking system for tracking a gaze direction of at least one eye relative to the helmet.

According to a further feature of the present invention, the eye-tracking system is associated with the processing system, the processing system calculating a gaze direction of the at least one eye relative to the predefined environment.

There is also provided according to the teachings of the present invention, a helmet position measuring system for determining the position of a helmet relative to a moving platform, the moving platform having an inertial navigation system, the system comprising: (a) an inertial measurement system associated with the helmet; (b) a communication link associated with both the helmet and the platform, the communication link transferring data from the inertial navigation system to the helmet; and (c) a processing system associated with the inertial measurement system and the communication link, the processing system processing data from the inertial measurement system and the data from the inertial navigation system to derive inertially-derived helmet position data indicative of the helmet position relative to the moving platform.

According to a further feature of the present invention, the processing system is configured to perform transfer alignment of the inertial measurement system from the inertial navigation system of the platform.

According to a further feature of the present invention, the inertial measurement system includes three angular motion sensors deployed in fixed relation to the helmet so as to sense rotational motion about three orthogonal axes.

According to a further feature of the present invention, the helmet has a convexly curved external surface, and wherein the three angular motion sensors are mounted in proximity to substantially mutually orthogonal regions of the curved external surface.

According to a further feature of the present invention, the helmet has a convexly curved external surface, the system further comprising a cover element attached to the helmet, the cover element having a concave sure facing the convexly curved external surface of the helmet, wherein the three angular motion sensors are mounted relative to the cover element at substantially mutually orthogonal regions of the concave surface.

According to a further feature of the present invention, there is also provided an optical measuring system associated with the processing system, the optical measuring system including: (a) at least three markers mounted on a first of the helmet and the moving platform; (b) at least one camera mounted on the other of the helmet and the moving platform for generating an image of at least the markers; and (c) image processing means for processing the image to generate optically-derived helmet position data, wherein the processing system is additionally for co-processing the inertially-derived helmet position data and the optically-derived helmet position data to generate overall helmet position information.

According to a further feature of the present invention, the camera is mounted on the helmet, and wherein the at least three markers are mounted on the moving platform.

According to a further feature of the present invention, the optical measuring system includes at least one illumination source mounted on the helmet, and wherein the at least three markers are passive reflective markers.

According to a further feature of the present invention, there is also provided a helmet-mounted eye-tracking system for tracking a gaze direction of at least one eye relative to the helmet.

According to a further feature of the present invention, the eye-tracking system is associated with the processing system, the processing system calculating a gaze direction of the at least one eye relate to the moving platform.

There is also provided according to the teachings of the present invention, a helmet assembly having a position measuring system, the helmet assembly comprising: (a) a helmet having a convexly curved external surface; and (b) an inertial measurement system including three angular motion sensors deployed in fixed relation to the helmet so as to sense rotational motion about three orthogonal axes, wherein the three angular motion sensors are mounted in proximity to substantially mutually orthogonal regions of the curved external surface.

There is also provided according to the teachings of the present invention, a helmet assembly having a position measuring system, the helmet assembly comprising: (a) a helmet having a convexly curved external surface; (b) a cover element attached to the helmet, the cover element having a concave surface facing the convexly curved external surface of the helmet, and (c) an inertial measurement system including three angular motion sensors for sensing rotational motion about three orthogonal axes, wherein the three angular motion sensors are mounted relative to the cover element at substantially mutually orthogonal regions of the concave surface.

There is also provided according to the teachings of the present invention, a method for reliable real-time calculation of pupil gaze direction over a wide range of angles, the method comprising: (a) illuminating an eye with electromagnetic radiation of at least one wavelength, (b) obtaining an image of the illuminated eye; (c) identifying within the image a pupil location; (d) automatically determining whether the image includes a direct corneal reflection; (e) if the image does not include a direct corneal reflection, calculating a current pupil gaze direction based upon the pupil location, the calculating being performed using a pupil-only gaze direction model, (f) if the image does include a direct corneal reflection, deriving a current pupil gaze direction based upon both the pupil location and a position of the direct corneal reflection.

According to a further feature of the present invention, at least one parameter of the pupil-only model is updated based upon at least one pupil gaze direction derived from both the pupil location and the position of direct corneal reflection.

### BRIEF DESCRIPTION OF THE DRAWINGS

The invention is herein described, by way of example only, with reference to the accompanying drawings, wherein:

FIG. 1 is a block diagram of a helmet system and related components, constructed and operative according to the teachings of the present invention, the helmet system including internal motion sensors, an optical position sensor arrangement and eye-tracking sensors;

FIG. 2 is a schematic representation of a preferred implementation of an inertial, or inertial-optical hybrid, helmet position subsystem, constructed and operative according to the teaching of the present invention, from the system of FIG. 1;

FIG. 3A is a schematic view of an implementation of the helmet system of FIG. 1;

FIG. 3B is a schematic representation of a preferred geometry of layout for the inertial sensors of the helmet system of FIG. 1 associated with a curved surface of a helmet;

FIG. 4 is a schematic representation of a preferred implementation of the optical position sensor arrangement of the helmet system of FIG. 1;

FIG. 5 is a flow diagram illustrating the operation of the optical position sensor arrangement of the helmet system of FIG. 1;

FIG. 6 is a schematic front view showing a preferred implementation of an eye tracking sensor of the helmet system of FIG. 1;

FIG. 7 is a schematic plan view of the eye tracking sensor of FIG. 6;

FIG. 8 is a photographic representation of an eye showing the pupil centroid and the direct corneal reflection of an illumination source;

FIGS. 9A-9C are schematic representations illustrating the effects of eye motion on pupil position and direct corneal reflection; and

FIG. 10 is a flow diagram illustrating a preferred mode of operation and corresponding method for deriving eye gaze direction according to the teachings of the present invention.

### DESCRIPTION OF THE PREFERRED EMBODIMENTS

The present invention provides a helmet position measuring system and a helmet mounted eye-gaze direction sensing system, together with associated methods.

The principles and operation of systems and methods according to the present invention may be better understood with reference to the drawings and the accompanying description.

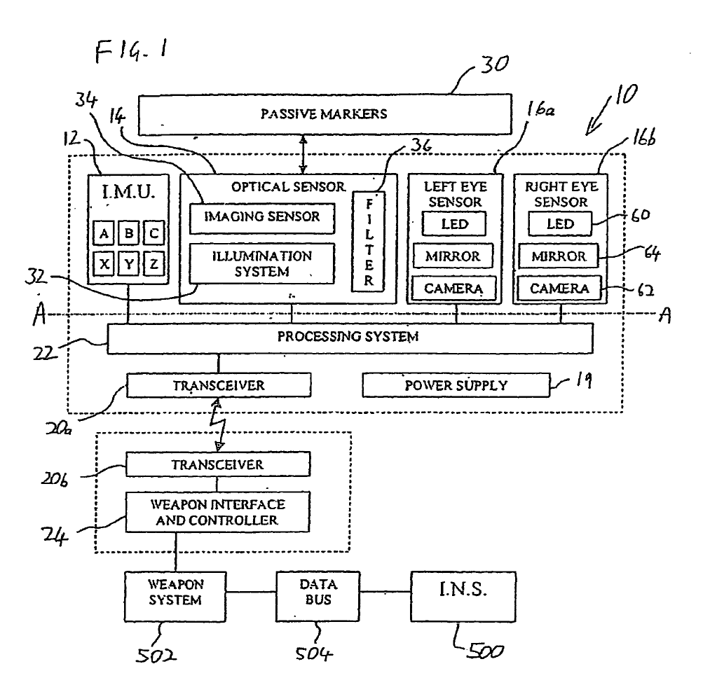

Referring now to the drawings, FIG. 1 shows a helmet system, generally designated 10, constructed and operative according to the teachings of the present invention, together with a number of related components. In general terms, the preferred embodiment of helmet system 10 shown here includes a number of subsystems each of which has utility in itself when used together with various otherwise conventional systems, but which are synergiously combined in the preferred embodiment as will be described. These subsystems include a helmet tracking system based upon one, or preferably both, of an inertial sensor system or inertial measurement unit (“IMU”) 2 and an optical sensor arrangement 14, and an eye-tracking system 16a 16b for tracking movement of one, or preferably both, eyes of a user.

Each of these subsystems and its particular novel features will be described separately below.

Two common considerations pervade preferred implementations of the various subsystems of the present invention. Firstly, each subsystem is preferably implemented either totally without integration into electronic systems of the platform, or at least minimizing any required integration as far as possible, as will be detailed below. This greatly simplifies the installation procedure and facilitates “retrofit” of the systems on existing platforms without requiring the same level of evaluation and testing as would be required for an integrated system.

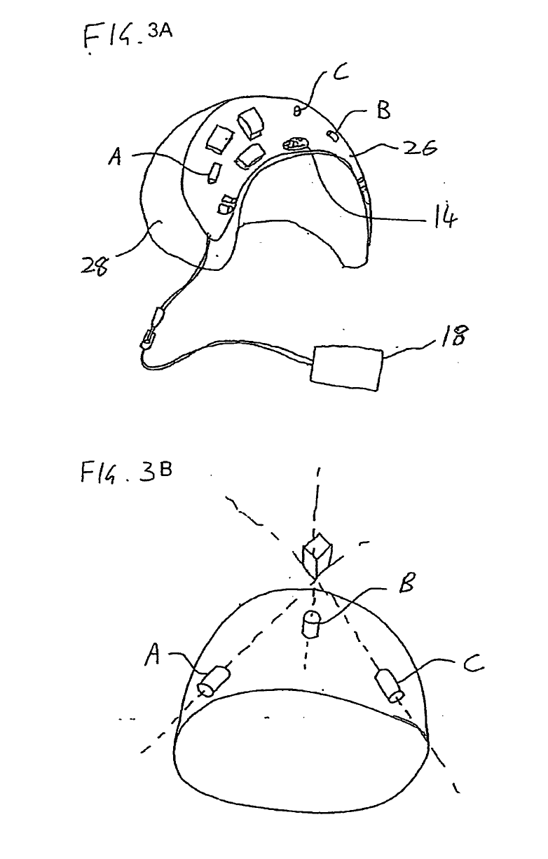

The second consideration pervading preferred implementations of the various subsystems of the present invention is the desire to minimize the excess weight and bulk of the helmet so that the helmet remains as close as possible to the size and weight of a conventional “dumb” helmet. To this end, any components which do not need to be helmet-mounted are preferably mounted in a separate body-mounted unit 18 (FIG. 3A) which is worn or otherwise strapped to the body of the user. This subdivision of components is represented schematically in FIG. 1 by dashed line A-A with components above the line being helmet-mounted and components below the line being body-mounted. Thus, in most preferred implementations, the total weight of all of the helmet-mounted electronic components of the system is no more than about 300 grams, and preferably no more than 200 grams. Furthermore, most preferred implementations of the helmet maintain the generally spherical outer shell shape of the helmet standing no more than about 6 cm, and preferably no more than about 4 cm, from the head of the user over substantially all of its surface. The result is a helmet which feels similar to a standard helmet and greatly reduces the physical stress on the user compared to existing hi-tech helmet systems.

In a further related consideration, the safety of the user is preferably enhanced by use of low power electronic components so as to avoid high-power connections between the helmet and platform systems. According to one option, a power supply 19 may be a self-contained battery unit, thereby avoiding power-supply connection to the platform. More preferably, a simple power-jack connector is used to supply low-voltage power to the helmet system. A battery power supply 19 may optionally be used to back-up the external power connection.

The various subsystems of preferred implementations of the invention will now be described individually.

### Inertial Helmet Position Subsystem

As mentioned earlier, helmet-mounted inertial tracking systems alone are insufficient to determine motion of a helmet relative to a non-inertial platform. To address this problem, the inertial tracking system of the present invention preferably provides an inertial measurement system which includes an inertial measurement unit 12 associated with the helmet, and a communication link (transceivers 20a and 20b) associated with both the helmet and the platform for conveying data from an inertial navigation system (“INS”) 500 of the platform to the helmet system. A processing system 22 associated with inertial measurement unit 12 and communication link 22a, processes data from inertial measurement unit 12 and from the inertial navigation system 500 to derive helmet position data indicative of the helmet position relative to the moving platform. Parenthetically, it should be noted that the term “helmet position” when used herein as a stand-alone term is used to refer to either or both of angular position (attitude) and linear spatial position (displacement). When referring to parameters of motion, the convention of “position”, “velocity” and “attitude” is used wherein “position” refers specifically to position in three-dimensional space relative to a set of reference coordinates.

In addition to the basic functionality of calculating differential motion, it is a further feature of particularly preferred implementations of the present invention that transfer alignment is used to “align” the reference axes of IMU 12 with the reference axes of INS 500, thereby enhancing the precision of the measurement, bringing the output of the small and relatively low-precision head-mounted system up to a precision close to that of the much more sophisticated platform INS. Transfer alignment is a well known technique, typically used for inertial measurement systems rigidly fixed, or at least tethered, to a common platform, for correcting one system on the basis of a more accurate system moving on the common platform. Transfer alignment has not heretofore been employed in a helmet tracking system and would conventionally be discounted as impossible since the helmet is essentially free to move with the head of the user relative to the platform. In practice, however, for a rapidly moving platform such as an aircraft, the present invention points out that the velocity of the helmet may be assumed for calculational purposes to be identical to that of the platform. Based upon this observation, the present invention teaches the use of transfer alignment for enhancing the precision of measurement. A further distinctive feature of preferred implementations of the transfer alignment of the present invention is that the moving platform NS motion data for performing the transfer alignment is transmitted to the helmet system wirelessly via the wireless communications link (transceivers 20a and 20b).

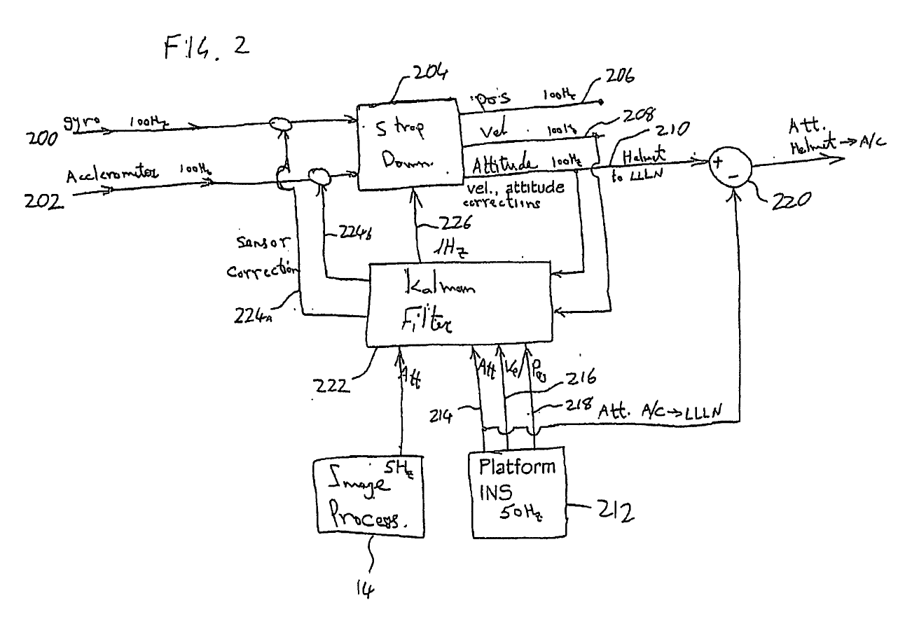

A preferred implementation of the inertial, or hybrid, helmet position subsystem is illustrated schematically in FIG. 2. The basic inertial helmet position calculation employs angular rate sensor inputs from a set of gyros at 200 and linear acceleration sensor inputs from a set of accelerometers at 202 which are processed by a strap-down processing module 204 of processing system 22. Strap-down processing module 204 employs standard inertial sensor integration techniques well known in the art to determine the motion parameters (position 206, velocity 208, attitude 210) of the helmet relative to a given frame of reference, referred to as “local-level local-North” (abbreviated to “LLLN”). The system also inputs at 212 the platform motion data from INS 500 for platform attitude 214, velocity 216 and position 218 relative to the given reference frame (LLLN). Helmet attitude 210 and platform attitude 214 are then co-processed at 220 to derive the motion, particularly the angular position or “attitude”, of the helmet relative to the platform, referred to herein as the “differential helmet motion”. This differential helmet motion is the output of the helmet tracking subsystem and is generated continuously at a refresh rate corresponding to the availability of the IMU and INS data, typically in the range of 50-100 Hz. Although illustrated here as deriving only the attitude of the helmet, which is typically the only motion data which is significant for determining directions to objects distant from the user, it will be clear that other motion parameters such as position or velocity can readily be retrieved by similar comparison of the corresponding outputs of strap-down processor 204 and the platform INS data.

In addition to the basic calculation module described thus far, the helmet motion data for velocity 208 and attitude 210, and the platform motion data for attitude 214, velocity 216 and position 218 are preferably fed to Kalman filter 222 which implements transfer alignment algorithm to generate corrections to increase accuracy of the inertial measurement unit output. Preferably, the corrections include sensor corrections 224a and 224b for correcting bias or other errors in the readings from the inertial sensors, and velocity and attitude corrections 226 which adjust the current output motion data parameters which also serve as the basis for the subsequent integrated motion data calculations. The implementation of the transfer alignment filter is essentially the same as is used conventionally in many “smart” weapon systems, and will not be discussed here in detail.

The connections 224a, 224b and 226 are typically updated at a rate limited primarily by the processing capabilities or by the quantity of data required for endive convergence of the transfer alignment calculations. A typical example for application of these corrections would be a rate of about 1 Hz.

As will be discussed further below, the helmet tracking system is preferably implemented as a hybrid system which includes additional helmet tracking subsystems, and most preferably, an optical helmet hacking system 14. In this case, Kalman filter 222 provides a highly effective tool for combining the available information from multiple sources, with differing refresh rates, and with self-adaptive relative weighting of the information sources. In the case of an optical subsystem which measures helmet attitude relative to the platform a preprocessing step is performed by filter 222 to transform the measurements by use of platform attitude data 214 into the LLLN frame within which the Kalman filter computation is performed.

As mentioned earlier, most preferred implementations of the present invention try to minimize integration of the subsystems with the platform electronics systems. In order to obtain the required data from the INS in a minimally integrated way, the communication link 22b is preferably a wireless communication link associated with a peripheral device which already has read-access to the INS data. In the preferred example illustrated here, communication link 22b is associated with a weapon interface and controller 24 which interface with a weapon system 502. Weapon system 502 is itself connected to a data bus 504 or equivalent dedicated wiring which makes available information from multiple systems of the platform, including from INS 500. Thus, weapon interface and controller 24 can access data from INS 500 without itself being directly integrated in the electronics systems of the platform.

By way of a practical example, in the case that weapon system 502 is an advanced missile system including one or more missile having its own internal INS, a data bus connection providing the missile system with aircraft INS data typically already exists in order to allow transfer alignment of the missile INS using the aircraft data as a reference. In this case, by tapping into the missile data directly, the data required by helmet system 10 may be retrieved without any modification of the aircraft hardware or software. The data connection may be achieved either through connection with a processing unit within the missile itself, or through connection with a processing unit within the missile launcher unit.

Turning now additionally to FIGS. 3A and 3B, the helmet-mounted IMU 12 typically has sets of linear and rotational motion sensors which need to be mounted in mutually orthogonal geometric relation. Specifically, the IMU typically includes three rotational rate sensors denoted “A”, “B” and “C”, and three linear accelerometers denoted “X”, “Y” and “Z” (FIG. 1). As mentioned earlier, it is a particular feature of most preferred implementations of the present invention that the helmet system maintains a low profile approximating to a conventional helmet profile. To this end, the present invention preferably makes use of the inherent curvature of the helmet surface to locate a set of three sensors where they can be mounted parallel to the local surface and still be mutually orthogonal to the other two sensors. In practice, this is typically achieved as shown in FIG. 3A by providing a cover element 26, similar to a standard visor cover, rigidly attached to the helmet 28. Cover element 26 is formed with a concave surface facing the corresponding convexly curved external surface of helmet 28. By suitable positioning of the angular motion sensors “A”, “B” and “C” (and/or linear motion sensors “X”, “Y” and “Z”), it can be ensured that they are mounted relative to the cover element at substantially mutually orthogonal regions of the concave surface. For clarity of presentation, cover element 26 is shown here to be transparent to reveal the underlying components. Alternatively, the components may be mounted directly under, or over, the convexly cured external surface of the helmet itself to achieve an equivalent geometrical arrangement. FIG. 3B is a schematic representation illustrating one possible choice of positions on a convexly (or concavely) curved surface which provide mutually orthogonal mounting positions.

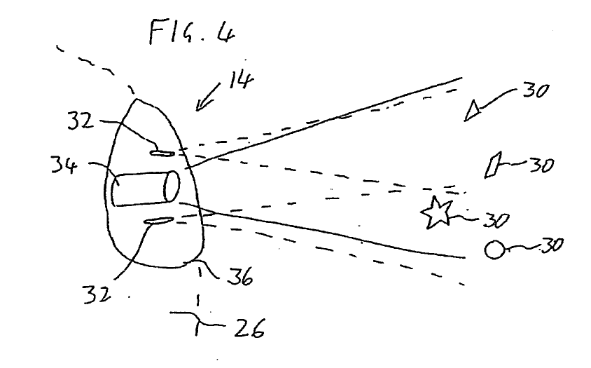

Although the inertial helmet position sensing system described thus far is believed to be highly effective in its own right, most preferred implementations of the present invention employ a hybrid helmet tracking system with a second preferably optical subsystem providing corrective data. A preferred example of the optical helmet position subsystem will now be described with reference to FIGS. 1, 2 and 4.

### Optical Helmet Position Subsystem

In order to provide an optical helmet position tracking system with minimal integration into systems of the platform, it is a particularly feature of most preferred implementations of the optical tracking system that the only “installed” elements outside the helmet system itself are passive reflectors 30, typically applied as stickers positioned within the cockpit or other working environment. At least three, and typically four, reflectors 30 are used, and they may have identical shapes and sizes, or may be geometrically distinct. The reflectors are preferably directional reflectors which reflect maximum intensity along a line roughly parallel with the incoming illumination.

In order to operate with passive reflectors 30, optical sensor arrangement 14 includes a helmet-mounted illumination system 32 for directing electromagnetic radiation of at least one wavelength from the helmet in at least one range of angles, and a helmet-mounted imaging system 34 sensitive to at least the at least one wavelength for deriving images of part of the predefined environment including electromagnetic radiation reflected from reflectors 30. Processing system 22 then processes the images to identify regions of the images corresponding to reflectors 30 and hence to determine information relating to a position of helmet 28 within the predefined environment.

Preferably, illumination system 32 includes at least one infrared LED, and most preferably two, three or four LED's which together cover substantially the entire field of view of imaging system 34. This preferably corresponds to a substantially continuous horizontal angular range of at least 60°, and a substantially continuous vertical angular range of at least 45°. In this context, the terms “horizontal” and “vertical” are used to refer to directions as perceived by the user in his or her normal orientation on the platform. Optionally, the optical system may be supplemented by one or more additional illumination system 32 and imaging system 34 mounted on the helmet with additional viewing directions in order to enlarge the range of angles over which reflectors 30 are within the FOV. Alternatively, an enlarged set of reflectors may be positioned to provide distinctive reflective symbols over an increased range of angles and/or in different viewing directions. For example, a secondary set of IR reflective stickers which are transparent to visible light may be deployed on a cockpit canopy to provide optical tacking when the user looks “up” in an aircraft frame of reference.

For reliable optical tracking, it is desired to achieve high contrast imaging of reflectors 30 while using low power illumination, despite the fiat that the system operates in an environment which may be exposed to direct solar radiation. Surprisingly, it has been found that these conditions can be met very successfully by employing directional reflectors (i.e., which return a majority of the reflected illumination intensity in a direction roughly parallel with the incoming illumination) in combination with narrow waveband wavelength selection. Thus, in most preferred implementations, at least the imaging system 34 is configured to be at least partially selective to electromagnetic radiation of a wavelength or wavelength band emitted by illumination system 32. This can be achieved most simply by positioning a suitable filter element 36 in front of at least the imaging sensor 34.

The calibration procedures and the processing required for position determination from the images obtained are known in the art and are typically similar to those of the commercially available systems mentioned earlier.

### Hybrid Helmet Tracker Function

Each of the aforementioned helmet tracking subsystems has its own advantages and disadvantages. The inertial system offers large bandwidth (rapid response) and operates over effectively limited angular range, but may suffer from errors or “drift”, particularly under low-acceleration conditions where insufficient data may be available for effective transfer alignment. The optical system on the other hand, once calibrated, offers repeatable accuracy and zero drift, but suffers from relatively slow response (typically around 5 Hz) and limited angular range. The two systems therefore complement each other perfectly to provide a hybrid helmet tracking system which combines the advantages of both subsystems. A preferred structure for integrating the measurements of the different subsystems was described above with reference to FIG. 2.

FIG. 5 shows a preferred sequence of operation of the optical helmet position subsystem itself. The optical sensor subsystem first obtains optical images via imaging system 34 (step 46) and processes the images to check whether sufficient markers 30 are within the current field of view (step 48). If insufficient markers are included in the sampled image, a new image is sampled (return to step 46). When sufficient markers are included in the field of view, the image is then processed to derive the helmet position relative to the platform (step 50). This helmet position data is then output at step 52 to the Kalman filter 222 FIG. 2) where it is combined with the other available data to provide optimal overall accuracy.

### Eve-Tracking Subsystem

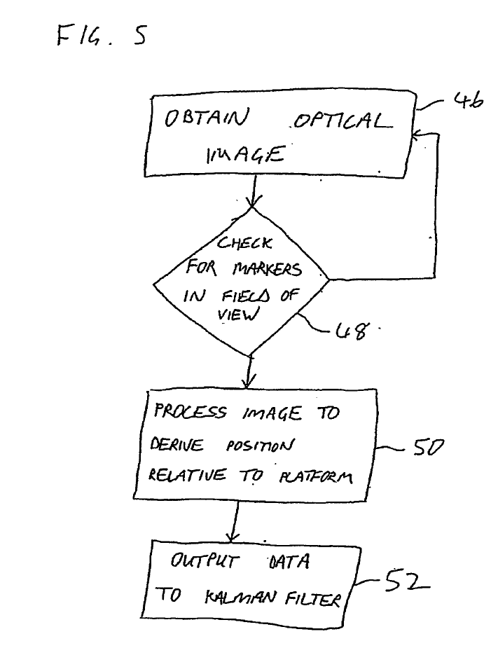

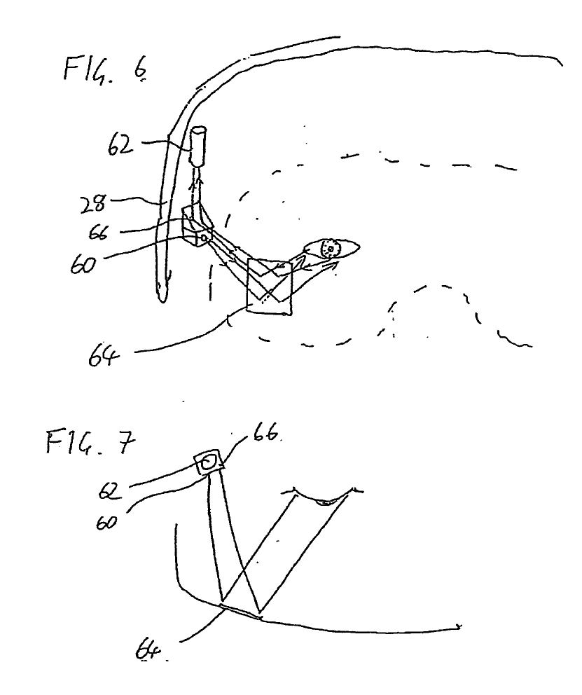

Turning now to the eye-tracking subsystem and associated method, a preferred structural layout of the eye-tracking optical components is illustrated in FIGS. 6 and 7. The components are essentially similar to those of conventional eye-tracking systems, namely, an infrared illumination system (LED 60) and an infrared imaging sensor (camera 62) deployed, respectively, for illumination and imaging an eye of the user. The geometrical arrangement is chosen, however, to minimize obscuration of the user's field of view and to facilitate mounting of the components within the conventional helmet profile. To this end, both LED 60 and camera 62 preferably view the eye via a “hot mirror” 64 mounted in front of the eye, typically on the internal surface of a visor. The term “hot mirror” is used herein to refer to an optical element which is reflective to the relevant frequencies of IR radiation while having high transparency to optical wavelengths of light an order to minimize the interference of outside light sources (including the sun) on measurements, the visor itself may advantageously be designed to exclude the relevant frequencies of IR radiation. In the case of an anti-laser visor for excluding certain wavelengths of incoming laser radiation, the already existing filtered wavelengths can be used to advantage by the eye tacking system. Alternatively, illumination and imaging may be performed in solar-blind frequency bands where ambient radiation levels are very low. An example of the resulting image is shown in FIG. 8 where the pupil region is clearly identifiable as the darkest region 100 and the glint is the brightest spot 102.

The use of hot-mirror 64 enables LED 60 and camera 62 to be located in the peripheral region of helmet 28 near the edge of the visor. For extra compact, depending upon the size and shape of camera 62, it may be advantageous to employ an extra mirror 66 to allow mounting of the camera vertically or in any other preferred orientation.

The eye-tracking subsystem also includes processing and data storage components, as well as power supply and driver circuitry, as will be clear to one ordinarily skilled in the art. The processing and data storage components are typically included in the general designation of processing system 22 (FIG. 1) and may be implemented as dedicated components within that system, or shared components which additionally serve other subsystems.

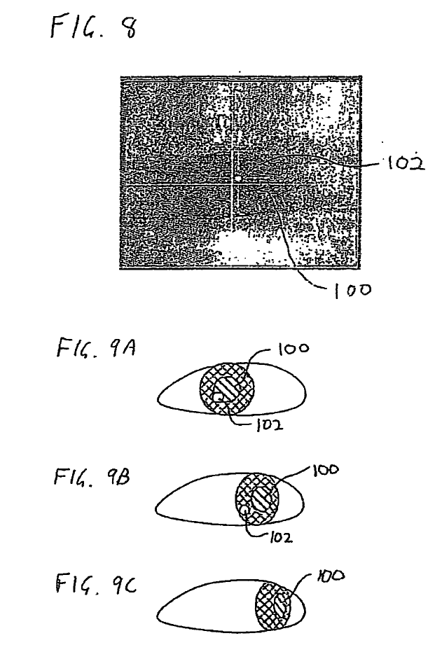

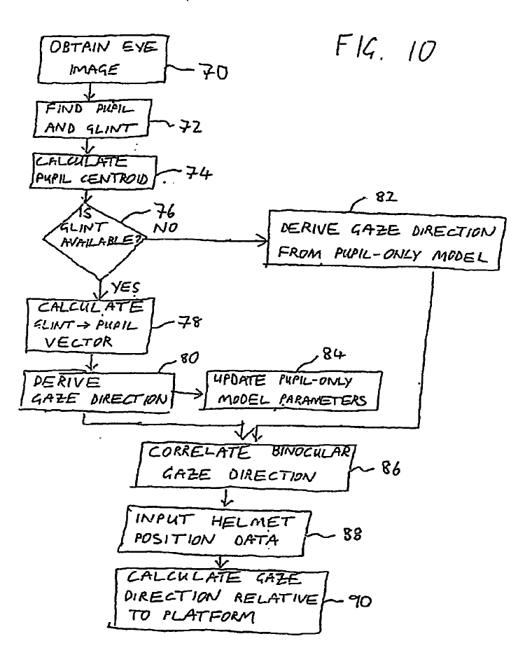

Turning now to the operation of the eye-tracking subsystem and the corresponding method, as mentioned earlier, there are two known techniques for deriving eye-gaze direction from images of the eye, referred to herein as “pupil-plus-glint” and “pupil only”. These individual techniques are known per se and are included in commercially available products as detailed in the background to the invention above. FIGS. 9A-9C illustrates a range of eye positions. In FIGS. 9A and 9B, both the pupil region 100 and the glint 102 are clearly visible. This allows use of the pupil-plus-glint gaze direction derivation which offers high precision and stability, and rejects helmet movements etc. In FIG. 9C however, the corneal reflection is lost due to the high angle of the eye relative to the illumination and imaging direction. According to the teachings of the prior art, if measurements are required at such high angles, the entire system would need to work in a pupil-only mode, with a consequent loss of precision and stability. For operational applications, this lack of stability could render the entire system ineffective.

To address this problem, it is a particularly preferred feature of the eye-tracking subsystem and corresponding method of the present invention that it combines the stability of the pupil-plus-glint tracking method with a range of tracking angles beyond the range which provides direct corneal reflection. This is achieved by using real-time automatic switching between two tracking calculation techniques, and most preferably, by automatic self-calibration of the pupil-only tracking technique based upon output of the pupil-plus-glint calculation technique during continuous operation of the system.

Turning specifically to FIG. 10, a method according to the present invention for reliable real-time calculation of pupil gaze direction over a wide range of angles obtains an image of the illuminated eye (step 70), preferably via the apparatus of FIGS. 6 and 7. The system then processes the image to identify the pupil and, if available, the corneal reflection or “glint” (step 72). These can be identified readily by threshold techniques alone, or in combination with other shape and/or position based algorithms. A centroid of the pupil position is then calculated (step 74), typically by best fit of an ellipse to the pupil region. At step 76, the system automatically determines whether the image includes a direct corneal reflection. If it does, the system proceeds at step 78 to calculate the vector between the glint centroid and the pupil centroid and to calculate the gaze direction based upon this vector (step 80). If the “glint” is not available, a gaze direction calculation is made at step 82 using a pupil-only gaze direction model. This “model” may be represented in any suitable form including, but not limited to, an algebraic formula and a look-up table or values.

According to most preferred implementations of the present invention, values of the gaze direction derived from the pupil-plus-glint calculation are used to update at least one parameter of the pupil-only model (step 84). In the case of an algebraic formula, this is typically done by adjusting one or more coefficient of the formula. In the case of a look-up table, adjustment may be made either to individual values or by scaling a plurality of values.

By updating the pupil-only model frequently, or substantially continuously, it can be ensured that the pupil-only model is optimize for the current position of the helmet and working conditions, thereby substantially eliminating the cumulative sources of error normally associated with the pupil-only eye-tracking technique.

According to a further supplementary, or alternative, aspect of the present invention, it is possible to provide multiple illumination directions of the eye such that at least one direct corneal glint is received by camera 62 over an enlarged range of gaze direction angles. The additional illumination directions are most simply achieved by providing additional hot-mirrors 64 suitably angled and positioned across the inner surface of the visor, each with its own illumination source (LED 60). Although it is possible to use multiple cameras for each eye to achieve a similar result, the use of a single camera with multiple illumination directions is typically preferred for its reduced image processing load. The matching of each glint with the corresponding illumination direction is typically straightforward by use of the relative geometry of the pupil and glint positions in the images. According to one preferred alternative implementation, a total of three or more illumination directions are used to ensure a direct glint over substantially the entire range of angular motion of the eye, thereby rendering the use of the pupil-only mode unnecessary.

In the preferred case of binocular eye tracking, the two individual eye-gaze directions are correlated at step 86. In the case of assumed far-vision parallel binocular fixation, the two individual gaze directions may be assumed to be parallel and can be combined to improve output accuracy. Each measurement may be given equal weight, or an adaptive filter technique may be used to give variable weight depending upon different regions of greater or lesser measurement accuracy for each eye, or as a function of which calculation technique was used for each eye.

In the case of the preferred combination of features of the present invention, the eye-gaze direction relative to the helmet is then combined with helmet position data input at step 88 and the gaze-direction relative to the platform is calculated (step 90).

### Additional Options

The helmet system described herein is useful for a wide range of different applications. In the specific version shown herein in the drawings, it is particularly useful as part of a system such as is described in the aforementioned co-assigned, co-pending U.S. Patent Application, published as Publication No. 20020039073 to provide a helmet-based cuing system without requiring a helmet mounted display. It should be noted, however, that any or all of the features of the present invention may equally be used to advantage in the context of a helmet which includes a helmet mounted display (HMD).

It should also be noted that the helmet system of the present invention, with or without a HMD, may also be used as a powerful tool for training or debriefing users. Specifically, it will be noted that preferred implementations of system 10 inherently generate helmet tracking information, eye tracking information and a forward-looking image from image system 34. By recording some or all of this data, optionally time-correlated to other actions of the user, databus information or external events, it is possible to reconstruct the movements of the user's head and his or her eye motion in the context of the forward view image. The data may either be recorded within data storage devices within processing system 22 or by a separate data storage unit (not shown) with a hard-wired or wireless one-directional communications link. The data storage device may optionally be part of an impact-protected disaster-investigation system.

By way of one non-limiting example, it is possible to replay the forward-view video images with the user's gaze direction superimposed thereon, thereby documenting the visual awareness of the user and the time-division of his or her attention. Optionally, the playback mode can simultaneously display flight information of the aircraft, as well as flight information of other aircraft or any other data or parameters available from the databus. The combined data can also be used to reconstruct the progression of events in three-dimensions.

It will be appreciated that the above descriptions are intended only to serve as examples, and that many other embodiments are possible within the scope of the present invention as defined in the appended claims.

What is claimed is:

1. A helmet position measuring system for use in a predefined environment, the system comprising:
(a) a helmet-mounted illumination system for directing electromagnetic radiation of at least one wavelength from the helmet in at least one range of angles;
(b) a set of at least three passive reflectors deployed at fixed positions in the predefined environment so as to reflect electromagnetic radiation from said illumination system;
(c) a helmet-mounted imaging system sensitive to at least said at least one wavelength for deriving images of part of the predefined environment including electromagnetic radiation reflected from said reflectors; and
(d) a processing system associated with said imaging system for processing said images to identify regions of said images corresponding to said reflectors and hence to determine information relating to a position of the helmet within the predefined environment.

2. The helmet position measuring system of claim 1, wherein said illumination system includes at least one eared LED.

3. The helmet position measuring system of claim 1, wherein said imaging system is at least partially selective to electromagnetic radiation of at least one wavelength.

4. The helmet position measuring system of claim 1, wherein said illumination system directs said electromagnetic radiation substantially continuously within a horizontal angular range of at least 60°.

5. The helmet position measuring system of claim 1, wherein said illumination system directs said electromagnetic radiation substantially continuously within a vertical angular range of at least 40°.

6. The helmet position measuring system of claim 1, wherein at least part of said processing system is located in a housing external to, and electrically interconnected with, the helmet, said housing being configured for wearing on the body of a user.

7. The helmet position measuring system of claim 1, further comprising an inertial measurement system associated with the helmet and connected to said processing system for providing additional information relating to a position of the helmet

8. The helmet position measuring system of claim 7, wherein said inertial measurement system includes three angular motion sensors deployed in fixed relation to the helmet so as to sense rotational motion about three orthogonal axes.

9. The helmet position measuring system of claim 8, wherein the helmet has a convexly curved external surface, and wherein said three angular motion sensors are mounted in proximity to substantially mutually orthogonal regions of said curved external surface.

10. The helmet position measuring system of claim 8, wherein the helmet has a convexly curved external surface, the system further comprising a cover element attached to the helmet, said cover element having a concave surface facing said convexly curved external surface of the helmet, wherein said three angular motion sensors are mounted relative to said cover element at substantially mutually orthogonal regions of said concave surface.

11. The helmet position measuring system of claim 7, wherein the predefined environment is part of a moving platform, the moving platform having at least one associated platform position measurement system, the helmet position measuring system further comprising a communications link associated with said processing system and with at least one element on the moving platform, said communication link transferring platform position information derived from said at least one platform position measurement system to said processing system, and wherein said processing system is configured to compute inertially-derived relative motion information relating to motion of the helmet within the predefined environment by comprising said information from said inertial measurement system with said platform position information.

12. The helmet position measuring system of claim 11, wherein said processing system is configured to employ an adaptive filter calculation to combine said inertially-derived relative motion information and said position information derived tom said images to generate overall helmet position information.

13. The helmet position measuring system of claim 11, wherein said communications link is implemented as a wireless communications link.

14. The helmet position measuring system of claim 13, wherein said communications link is associated with at least one of the group: a processing unit within a missile; and a processing unit within a missile luncher.

15. The helmet position measuring system of claim 1, further comprising a helmet-mounted eye-tracking system for tracking a gaze direction of at least one eye relative to the helmet.

16. The helmet position measuring system of claim 15, wherein said eye-tracking system is associated with said prong system, said prong system calculating a gaze direction of the at least one eye relative to the predefined environment

17. A helmet position measuring system for determining the position of a helmet relative to a moving platforms the moving platform having an inertial navigation system, the system comprising:
(a) an inertial measurement system associated with the helmet;
(b) a communication link associated with both the helmet and the platform, said communication link transferring data from the inertial navigation system to the helmet; and
(c) a processing system associated with said inertial measurement system and said communication link, said processing system processing data from said inertial measurement system and said data from the inertial navigation system to derive inertially-derived helmet position data indicative of the helmet position relative to the moving platform.

18. The helmet position measuring system of claim 17, wherein said processing system is configured to perform transfer alignment of the inertial measurement system from the inertial navigation system of the platform.

19. The helmet position measuring system of claim 17, wherein said inertial measurement system includes three angular motion sensors deployed in fixed relation to the helmet so as to sense rotational motion about three orthogonal axes.

20. The helmet position measuring system of claim 19, wherein the helmet has a convexly curved external surface, and wherein said three angular motion sensors are mounted in proximity to substantially mutually orthogonal regions of said curved external surface.

21. The helmet position measuring system of claim 19 wherein the helmet has a convexly curved external surface, the system further comprising a cover element attached to the helmet, said cover element having a concave surface facing said convexly curved external surface of the helmet, wherein said three angular motion sensors are mounted relative to said cover element at substantially mutually orthogonal regions of said concave surface.

22. The helmet position measuring system of claim 17, further comprising an optical measuring system associated with said processing system, said optical measuring system including:
(a) at least three markers mounted on a first of the helmet and the moving platform;
(b) at least one camera mounted on the other of the helmet and the moving platform for generating an image of at least said markers; and
(c) image processing means for processing said image to generate optically-derived helmet position data,
wherein said processing system is additionally for co-processing said inertially-derived helmet position data and said optically-derived helmet position data to generate overall helmet position information.

23. The helmet position measuring system of claim 22, wherein said camera is mounted on the helmet, and wherein said at least tree markers are mounted on the moving platform.

24. The helmet position measuring system of claim 23, wherein said optical measuring system includes at least one illumination source mounted on the helmet, and wherein said at least three markers are passive reflective markers.

25. The helmet position measuring system of claim 17, further comprising a helmet-mounted eye-tracking system for tracking a gaze direction of at least one eye relative to the helmet.

26. The helmet position measuring system of claim 25, wherein said eye-tracking system is associated with said processing system, said processing system calculating a gaze direction of the at least one eye relative to the moving platform.

27. A helmet assembly having a position measuring system, the helmet assembly comprising:
(a) a helmet having a convexly curved external surface, and
(b) an inertial measurement system including three angular motion sensors deployed in fixed relation to the helmet so as to sense rotational motion about three orthogonal axes, wherein said three angular motion sensors are mounted in proximity to substantially mutually orthogonal regions of said curved external surface.

28. A helmet assembly having a position measuring system, the helmet assembly comprising:
(a) a helmet having a convexly curved external surface;
(b) a cover element attached to the helmet, said cover element having a concave surface facing said convexly curved external surface of the helmet; and
(c) an inertial measurement system including three angular motion sensors for sensing rotational motion about three orthogonal axes, wherein said three angular motion sensors are mounted relative to said cover element at substantially mutually orthogonal regions of said concave surface.

29. A method for reliable real-time calculation of pupil gaze direction over a wide range of angles, the method comprising:
(a) illuminating an eye with electromagnetic radiation of at least one wavelength;
(b) obtaining an image of the illuminated eye;
(c) identifying within said image a pupil location;
(d) automatically determining whether said image includes a direct corneal reflection;
(e) if said image does not include a direct corneal reflection, calculating a current pupil gaze direction based upon said pupil location, said calculating being performed using a pupil-only gaze direction model;
(f) if said image does include a direct corneal reflection, deriving a current pupil gaze direction based upon both said pupil location and a position of said direct corneal reflection.

30. The method of claim 29, further comprising updating at least one parameter of said pupil-only model based upon at least one pupil gaze direction derived from both said pupil location and said position of direct corneal reflection.
